(19) United States
(12) Patent Application Publication
(10) Pub. No.: US 2011/0072699 A1
(43) Pub. Date: Mar. 31, 2011

(54) DISPLAY DEVICE

(76) Inventor: Takahiro Ikunami, Tokyo (JP)

(21) Appl. No.: 12/994,708

(22) PCT Filed: Apr. 8, 2009
(86) PCT No.: PCT/JP2009/001639

§ 371 Date: Nov. 24, 2010

(30) Foreign Application Priority Data
Jul. 2, 2008 (JP) 2008-173645

(51) Int. Cl. G09F 9/00

(52) U.S. Cl. 40/606.15

(57) ABSTRACT

A display device is arranged such that a hinge cover 26 for covering a hinge mechanism 17 that supports a shaft 13 of a display 3 in a display device 1 with a bracket 14 is formed integral with an inner cover 12 of a display device main body 2.

### TECHNICAL FIELD

The present invention relates to a display device having a hinge mechanism that openably and closably supports a display.

### BACKGROUND ART

Recent automotive vehicles include one having provided therein a display device for a television, DVD, game, or the like, intended for a rear seat occupant. In a vehicle including three-row seats or opposed seats, a display device is mounted on a ceiling thereof. Such a display device is composed of a display device main body and a display (monitor) rotatable to the main body. The display is used with held at a predetermined angle with respect to the display device main body.

The display is rotatably supported by a hinge mechanism supporting a shaft provided on the display with a bracket that is fixed on the side of the display device main body. Patent Document 1 discloses a display device including such a hinge mechanism. A shaft projecting laterally from both the ends at the bottom portion of a display is rotatably passed through a bracket. The bracket is fixed to a bracket base of the device. A click plate having a convexity is attached integrally to the shaft. Two or more concavities to be fit in the convexity are provided on the bracket. The shaft rotates together with the display, and the convexity of the click plate fits in one of the concavities of the bracket, thus positioning the display. Grease is applied to the rotating portion between the shaft and the bracket in order to maintain the rotation performance thereof.

### PRIOR ART DOCUMENTS

### Patent Documents

Patent Document 1: JP-A-2006-168402

In the display device disclosed in Patent Document 1, dust can adhere to the grease applied of the hinge mechanism to affect the operation load of the display. In the words, smooth rotations of the display can be hindered. In order to avoid such an inconvenience, it is conceived to provide a cover over the hinge mechanism. However, to provide separately the cover increases the number of components, resulting in a cost increase.

The present invention has been made to solve the above-described technical problems, and an object of the present invention is to prevent dust from adhering to a rotating portion by covering a hinge mechanism of a display device without causing a cost increase.

### SUMMARY OF THE INVENTION

The display device according to the present invention includes a hinge mechanism in which a shaft projecting laterally from a display is rotatably supported by a bracket, and is arranged such that the bracket of the hinge mechanism is fixed to a display device main body, wherein in the interior of the bracket, a click plate having a convexity is provided integral with the shaft on the bracket side thereof, and also a concavity engageable with the convexity is provided on the bracket side, and wherein a hinge cover for covering the hinge mechanism is formed integral with an inner cover provided on the display device main body.

According to the display device of the present invention, since a cover for covering the hinge mechanism is configured to be formed integral with the inner cover of the display device, the hinge mechanism or the like can be covered without causing a cost increase to thus prevent adhesion of dust to grease.

### BRIEF DESCRIPTION OF THE DRAWINGS

FIG. 1 is a schematic sectional view taken along the side of a display device in accordance with the first embodiment with a display thereof opened.

FIG. 2 is a schematic sectional view taken along the side of the display device in accordance with the first embodiment with the display thereof closed.

FIG. 3 is a perspective view of a hinge mechanism of the display device in accordance with the first embodiment.

FIG. 4 is a sectional view of the hinge mechanism of the display device in accordance with the first embodiment.

FIG. 5 is a sectional view of the hinge mechanism of a display device in accordance with the second embodiment.

### BEST MODE FOR CARRYING OUT THE INVENTION

Embodiments of the present invention will now be described with reference to the accompanying drawings in order to explain the present invention in more detail.

### First Embodiment

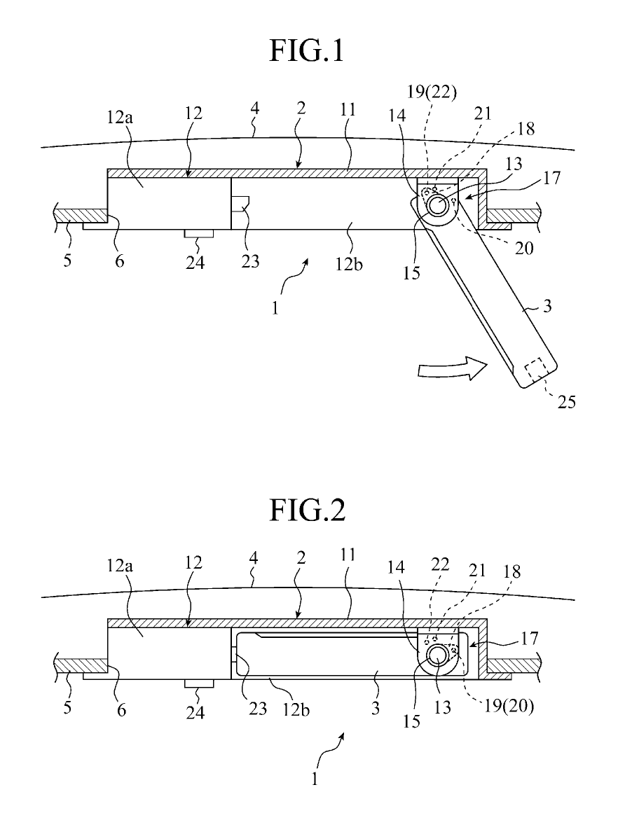

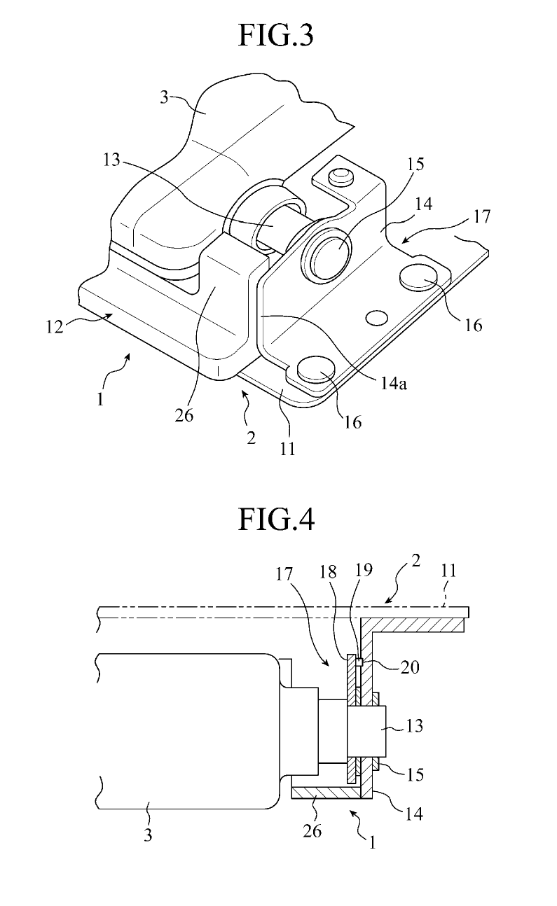

In the first embodiment, the present invention is applied to a display device mounted on the ceiling of a vehicle. FIG. 1 and FIG. 2 are schematic sectional views taken along the side of a display device in accordance with the first embodiment, with the display thereof opened and closed, respectively. FIG. 3 is a perspective view of a hinge mechanism thereof, and FIG. 4 is a sectional view of the mechanism.

A display device 1 is composed of a display device main body 2 and a display 3 assembled openably and closably to the display device main body 2. The display device 1 is attached to a roof lining 5 provided in the interior of a roof 4 of a vehicle. The display device is attached to a mounting hole 6 provided through the roof lining 5 by fitting and screwing the display device main body 2 in the hole, or using an equivalent method.

The display device main body 2 has a structure such that equipments (a controller and so on) required for the display device 1a are assembled to a metallic base 11 to be covered with an inner cover 12. The inner cover 12 is composed of an equipment housing section 12a for covering the equipment on the base 11 and a concave display housing space 12b for housing the display 3. The inner cover 12 is molded of, e.g., a plastic or the like.

A shaft 13 is protruded laterally from both the sides of the base portion of the display 3, and the shaft 13 is rotatably supported by a bracket 14. The shaft 13 is fastened by a fastener 15 from the exterior of the bracket 14 so as not to get detached therefrom. The bracket 14 is secured to the base 11 of the display device main body 2 with screws 16. In such a way, a hinge mechanism 17 for enabling the display 3 to rotate is constituted by the shaft 13, the bracket 14 and so on.

In the interior of the bracket 14, a click plate 18 is provided integral with the shaft 13. For a method of providing the click plate 18 integral with the shaft 13, it is conceived by, e.g., creating a plane section on the shaft 13, forming a hole of the same shape as the cross-sectional shape of the section in the click plate 18, and further engaging the hole with the portion having the plane section of the shaft 13. The click plate 18 is assembled to the shaft 13 so as not to be displaced also in an axial direction thereof. A convexity 19 is provided on the surface of the click plate 18 on the bracket 14 side. On the other hand, concavities 20, 21, and 22 are provided on the inner surface of the bracket 14 in positions corresponding to the convexity 19 of the click plate 18: in a closed state of the display 3; and in states opened, e.g., 90 and 120 degrees from the closed state, respectively. The click plate 18 is made of a metal or the like, and is assembled to the bracket 14 such that the convexity 19 thereof is elastically pressed against the bracket.

Therefore, when the display 3 is opened and set to the position of 90 degrees, the convexity 19 of the click plate 18 is fit in the concavity 21 located in the position of 90 degrees to position and hold the display; when the display 3 is further rotated, so that the convexity 19 of the click plate 18 is fit in the concavity 22 of the bracket 14, the display 3 is positioned and held in the position that is opened 120 degrees. When the display 3 is closed to be housed in the display housing section 12b of the inner cover 12, the convexity 19 of the click plate 18 is fit in the concavity 20 of the bracket 14, thus holding the display in an accommodation state.

A latch 23 is provided from the equipment housing section 12a of the inner cover 12 toward the display housing section 12b. The latch 23 is configured to be elastically retractable by a spring. An operation button 24 is provided on the surface of the equipment housing section 12a, and the latch 23 is configured to be retracted into the equipment housing section 12a by pushing the operation button 24. On the other hand, a latch engaging hole 25 is provided at the end of the rotation side of the display 3. When the display 3 is closed, the latch 23 is fit into the latch engaging hole 25 to hold the display 3. The operation button 24 is pushed to draw the latch 23 from the latch engaging hole 25, thus enabling the display 3 to rotate.

In the hinge mechanism 17 including the shaft 13, the bracket 14, and so on, it is required to prevent dust from adhering to the fit between the shaft 13 and the bracket 14. It is noted that the fit between the shaft 13 and the bracket 14 is filled with grease if necessary. In the embodiment, as shown in FIG. 3, a hinge cover 26 for covering the hinge mechanism 17 is formed over the inner cover 12. The hinge cover 26 is formed so as to close a clearance with the sidewall 14a of the bracket 14, and further cover the side of the hinge mechanism 17. The shape of the bracket 14 is not limited to such a shape, and the bracket can be formed so as to cover the upside of the hinge mechanism 17 if space permits. The hinge cover 26 is plastic-molded integrally with the inner cover 12.

According to the display device 1 of the first embodiment, since the hinge mechanism 17 is covered with the hinge cover 26, intrusion of dust into the hinge mechanism 17 is blocked; thus, it is prevented to have an effect on the operation load due to the adherence of dust. Further, the hinge cover 26 is molded integral with the inner cover 12; thus, the number of components and the number of assembling steps are not increased to cut down on costs.

### Second Embodiment

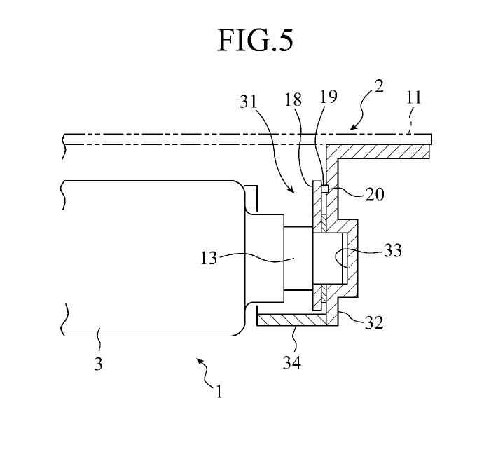

FIG. 5 shows a structure of a hinge mechanism 31 of a display device in accordance with the second embodiment. The hinge mechanism 31 has a structure such that a shaft housing concavity 33 is provided in a bracket 32, and the end of a shaft 13 is fitted thereinto to rotatably support the shaft 13. The structure where a click plate 18 is provided on the shaft 13, and the structure where positioning concavities are provided in the bracket 32 are the same as those of the first embodiment. The fit between the shaft housing concavity 33 of the bracket 32 and the end of the shaft 13 is filled with grease as needed. Also in this structure, a hinge cover 34 for covering the hinge mechanism 31 is molded integral with an inner cover 12.

According to the display device of the second embodiment, since the hinge mechanism 31 is covered with the hinge cover 34, intrusion of dust into the hinge mechanism 31 is blocked; thus, it is prevented to have an effect on the operation load due to the adherence of dust. The hinge cover 34 is molded integral with the inner cover 12; thus, the number of components and the number of assembling steps are not increased to cut down on costs. Furthermore, in accordance with the second embodiment, since the end of the shaft 13 is not extended externally from the bracket 32, the intrusion of dust into the hinge mechanism 31 is blocked more positively.

### INDUSTRIAL APPLICABILITY

As discussed above, the display device according to the present invention, in order to cover the hinge mechanism and the periphery thereof without causing a cost increase to prevent dust from adhering to the rotating portion thereof, the display device includes a hinge mechanism in which a shaft projecting laterally from a display is rotatably supported by a bracket, and the device is arranged such that the bracket of the hinge mechanism is fixed to a display device main body, wherein in the interior of the bracket, a click plate having a convexity is provided integral with the shaft on the bracket side thereof, and also a concavity engageable with the convexity is provided on the bracket side, and wherein a hinge cover for covering the hinge mechanism is formed integral with an inner cover provided on the display device main body. Thus, the display device is suitable for use in a display device or the equivalent which is installed for a rear seat occupant in recent automotive vehicles.

1. A display device that includes a hinge mechanism in which a shaft projecting laterally from a display is rotatably supported by a bracket, and that is arranged such that the bracket of the hinge mechanism is fixed to a display device main body,
wherein in the interior of the bracket, a click plate having a convexity is provided integral with the shaft on the bracket side thereof, and also a concavity engageable with the convexity is provided on the bracket side, and
wherein a hinge cover for covering the hinge mechanism is formed integral with an inner cover of the display device main body.

2. The display device according to claim 1, wherein the shaft is fit in the supporting concavity provided in the bracket to be supported.
